(19) United States
(12) Patent Application Publication
(10) Pub. No.: US 2010/0272320 A1
(43) Pub. Date: Oct. 28, 2010

(54) Laser Pointing System

(75) Inventors: François-Xavier Doittau, Behoust/Orgerus (FR); Jean-Paul Pocholle, La Norville (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/809,278

(22) PCT Filed: Dec. 5, 2008
(86) PCT No.: PCT/EP08/66926

§ 371 Date: Jun. 18, 2010

(30) Foreign Application Priority Data
Dec. 18, 2007 (FR) 0708842

(51) Int. Cl. G06K 9/00

(52) U.S. Cl. 382/106

(57) ABSTRACT

A system for pointing a laser beam is provided. The system comprises at least one processing laser source for emitting a processing laser beam toward a target, said processing beam being transmitted through a non-reflective zone of a first mirror, said mirror allowing return to an imaging system receiving an illumination beam reflected by the target, said low reflection coefficient zone of the first mirror inducing a shadow zone toward the imaging system; a second mirror receiving said processing beam and intended to orient it and reflect it toward the target; an illumination source for illuminating said target with the aid of the illumination beam, a first control circuit for controlling the orientation of said pointing system toward the target, a second control circuit for angularly displacing the processing beam by a determined angle, measuring the distance separating the position of a zone of the target from the position of the spot of the processing beam on the basis of an image obtained by the imaging system, then displacing the illumination beam in the opposite sense by an angle corresponding to said measured distance, the angular displacement of the processing beam having an amplitude such that the measurement of the position of the target is not perturbed by the shadow zone.

The invention relates to a system for pointing a laser, and in particular a laser with high average power. It also relates to a laser imaging system and to a system for pointing a plurality of optical sources.

### PRIOR ART

In systems for processing by optical laser beams, it may be necessary to direct the processing laser beam with precision onto the target to be processed. It may therefore be necessary to know the point of impact of the processing beam on the target precisely.

To this end, it is known to use imaging systems making it possible to have an image of the target and the point of impact of the processing beam on the target. The system can then modify the orientation of the processing beam as a function of the image obtained.

In order to carry out this imaging, known systems generally transmit an illumination beam toward the target. An imaging system receives the light reflected by the target and identifies the position of the target.

However, the transmission of the processing beam and the transmission of the illumination beam often use the same optical circuits. The reception by the imaging system can therefore be perturbed by the system for transmitting the processing beam, in particular when the target has small dimensions.

The invention makes it possible to overcome this drawback.

The invention may be used more particularly in sighting systems in which a reflection system makes it possible to use the same optics for the transmission of the processing beam and for the imaging.

### SUMMARY OF THE INVENTION

The invention therefore relates to a system for pointing a laser beam, characterized in that it comprises:
at least one processing laser source for emitting a processing laser beam toward a target, said processing beam being transmitted through a non-reflective zone of a first mirror, said mirror allowing the light reflected by the target to return to the imaging system, said low reflection coefficient zone of the first mirror inducing a shadow zone toward the imaging system;
a second mirror receiving said processing beam and intended to orient it and reflect it toward the target;
an illumination source for illuminating said target with the aid of the illumination beam,
a first control circuit for controlling the orientation of said pointing system toward the target,
a second control circuit for angularly displacing the processing beam by a determined angle, measuring the distance separating the position of a zone of the target from the position of the spot of the processing beam on the basis of an image obtained by the imaging system, then displacing the illumination beam in the opposite sense by an angle corresponding to said measured distance, the angular displacement of the processing beam having an amplitude such that the measurement of the position of the target is not perturbed by the shadow zone.

The mirror M2 fulfils a twofold function: fine stabilization of the pointing through CT and on the basis of the signals output by CA, and displacement of the processing beam in order to avoid the perturbation caused by the shadow zone.

These two functions may be carried out by two dedicated mirrors (one providing the fine stabilization and the other the diversion) in order to shorten the time for which the processing beam is away from the target while reducing the inertia of the diversion mirror.

According to one embodiment of the invention, said processing beam is transmitted through a non-reflective zone of a first mirror, said mirror allowing the light reflected by the target to return to the imaging system. This low reflection coefficient zone of the first mirror induces a shadow zone toward the imaging system.

According to this embodiment, said angle by which the processing beam is angularly displaced corresponds in the imaging system to the diameter of said shadow zone.

According to another alternative embodiment, the system of the invention comprises a third mirror intended to reflect the light received from the second mirror toward said target, or conversely to reflect the light received from the target toward the second mirror, this third mirror making it possible to adjust the focusing of the beam received from the second mirror.

According to another alternative embodiment, the system of the invention comprises a fourth mirror receiving the light received from the first mirror and reflecting it toward the imaging system.

According to an advantageous embodiment of the invention, said processing beam has a first wavelength or wavelength range and said illumination beam has a second wavelength or wavelength range, different to the first wavelength or wavelength range. The system furthermore comprises a spectral filter, located between the first mirror and the imaging system, for transmitting only the second wavelength or wavelength range to the imaging system.

Advantageously, the processing laser source comprises an emitting optical fiber or an assembly of a plurality of emitting optical fibers, one end of which lies flush with said reflective face. The surface of said end constitutes said zone which reflects little or not at all. The reflective face and the surface of said end lie in the same plane and are inclined with respect to the axis of the emitting optical fiber or the assembly of emitting optical fibers.

According to an alternative embodiment, said first mirror comprises a face coated with a volume diffraction grating which comprises a hole in said zone for said processing beam to pass through and employs conservation of the quasi-monochromatic character of the radiation emitted by the illumination laser after reflection by the target in order to angularly separate the processing channel from the imaging channel.

### BRIEF DESCRIPTION OF THE FIGURES

The various subjects and characteristics of the invention will become more readily apparent in the following description and the appended figures, in which:

FIG. 1 represents an exemplary embodiment of an optical imaging system to which the invention may be applied,

FIGS. 2a and 2e represent an example of the optical pointing method according to the invention,

FIGS. 3 and 4 represent exemplary embodiments of mirrors which may be used in the method and in the system of the invention,

FIG. 5 represents an optical pointing system employing the method according to the invention.

### DETAILED DESCRIPTION

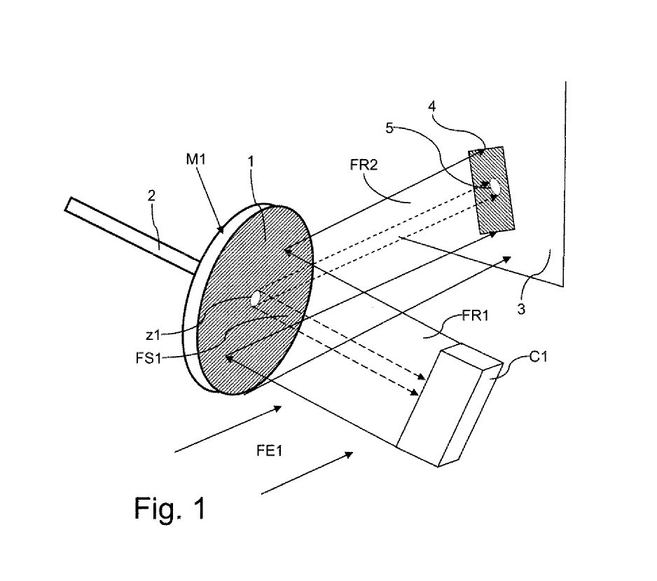

Referring to FIG. 1, an example of a system for pointing a laser beam, to which the invention is applied, will therefore be described first.

According to this example, an optical fiber 2 passes through a mirror M1. The reflective surface 1 of the mirror M1 is provided with a zone z1 which is non-reflective (or reflects little in comparison with the overall surface 1) and through which the fiber 2 can emit a processing light beam FS1 toward a localized zone of the target C1. Under these conditions, an optical source can emit a light beam through this zone z1, but on the other hand light incident on the mirror M1 is reflected by the reflective surface 1 except by the zone z1.

In addition, the target C1 is illuminated by an imaging light beam FE1. In return, the target C1 reflects a beam FR1. The latter is reflected by the surface 1 of the mirror M1 in the form of the beam FR2 toward an imaging system or photographic device 3. The displayed image 4 is therefore the image of the target. Furthermore, the portion of the beam FR1 which reaches the mirror in the zone z1 is not (or almost not) reflected by the mirror M1. In the image 4 of the target, there is therefore a less luminous zone 5 which we will refer to as the “blind zone”. This zone corresponds to the zone z1 of the mirror M1. In this zone, the photographic device sees no detail of the target.

The imaging system of FIG. 1 therefore makes it possible to visualize the impact zone on the target C1 of the beam FS1 emitted by the optical fiber 2. By visualizing the image 4 obtained by the photographic device, an operator or an image processing system can therefore modify the impact zone on the target by modifying the orientation and/or the focusing of the beam FS1.

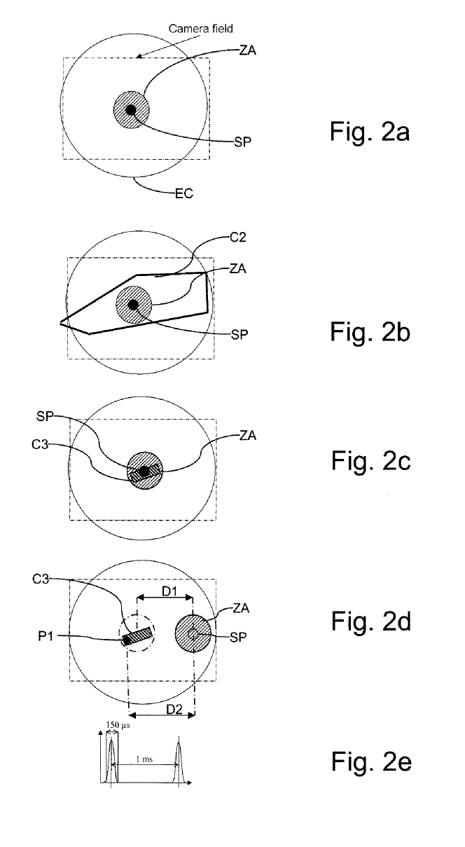

FIG. 2a represents the image on a camera screen (in dots and dashes on the figure) of a zone EC of illumination by the imaging beam (FE1 in FIG. 1). Inside the zone EC lies the processing spot SP emitted by the source S1, which is located in a shadow zone or blind zone ZA as explained above.

In the case of a large target C2 represented in FIG. 2b, the blind zone ZA is smaller than the target and the spot SP can be located on the target.

In the case of a small target C3 (FIG. 2), however, the image of the target C3 is entirely contained in the blind zone ZA and therefore cannot be seen, or is difficult to see, with the aid of the camera. The image obtained by the photographic device therefore does not make it possible to locate with precision the position of the target, and in particular the impact zone of the processing beam on the target.

The invention therefore relates to a method which makes it possible to overcome this drawback.

According to the method of the invention, pre-pointing of the processing beam FS1 toward the target is therefore carried out. This pre-pointing is carried out according to the known techniques, and does not require great precision.

In the case of a small target whose image in the photographic device is contained in the blind zone ZA, the method of the invention then consists in angularly displacing the processing beam FS2 (FIG. 2) by a known angle so as to offset the blind zone with respect to the target on the image of the photographic device, by a distance D1 at least equal to the diameter of the blind zone. In FIG. 2d, the image obtained is such that instead of having the blind zone (in dots and dashes on the figure) lying on the target C3, it is now offset by a distance D1.

Under these conditions, the camera makes it possible to see an image such as that in FIG. 2d, which shows on the one hand the target C3 and on the other hand the blind zone ZA.

In FIG. 2d, the spot of the processing beam SP has been indicated at the center of the blind zone ZA.

With the aid of the image in FIG. 2d, the distance D2 between the center of the blind zone (which corresponds to the center of the spot of the processing beam) and a determined zone P1 of the target C3 intended to be processed with the processing beam is measured.

An inverse angular displacement of the processing beam is then carried out, by an angle corresponding to the distance D2 determined in this way. The system can then emit the processing beam toward the zone P1 of the target.

As illustrated by FIG. 2e, the perturbation of the processing beam may not exceed 150 μs per millisecond, i.e. 15% of the time during which the processing laser can be neutralized in emission, so as not to compromise the overall efficiency while ensuring photonic isolation of the camera in relation to the processing laser.

In the system of FIG. 1, the mirror M1 may be produced with the aid of a block in which a fiber 2 has been embedded. One face 1 of the block B1 is machined along a plane which is inclined with respect to the axis of the fiber 2. This face 1 is then rendered reflective (for example metalized) and, in the reflective surface obtained, the zone z1 is rendered non-reflective. To this end, for example, a sufficiently energetic light beam is transmitted by the fiber 2 in order to degrade the reflective surface at the position of the zone z1.

FIG. 4 represents an alternative embodiment of the mirror M1. It comprises a support plate S1, one face of which is coated with a layer of a polymer material in which a volume diffraction grating has been recorded (Bragg grating). Furthermore, a hole T1 passes through the support plate and the diffraction grating so as to make it possible to install a fiber (or a set of fibers), the emission end of which allows light emission through the zone z1.

Referring to FIG. 5, a more complete pointing system for carrying out the pointing method according to the above-described invention will be described.

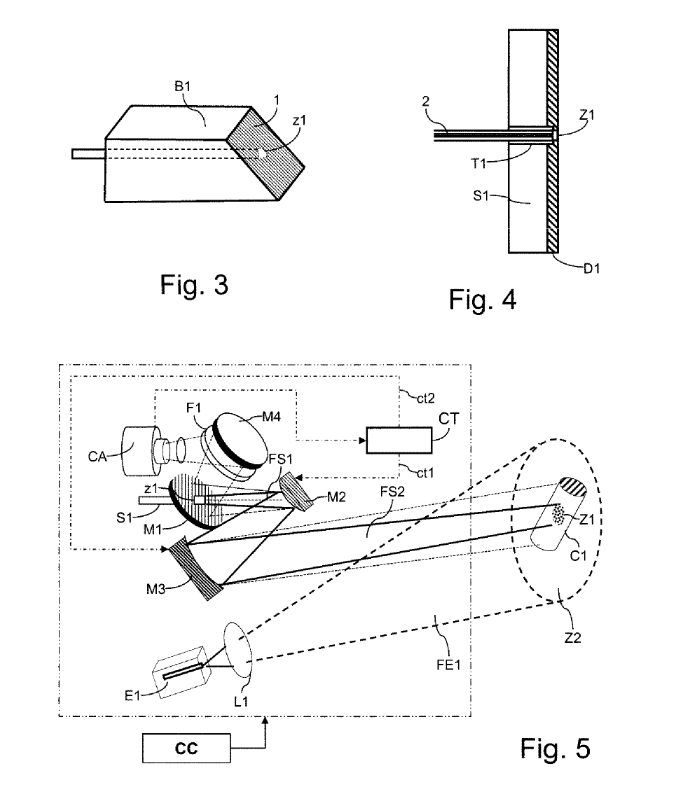

A source S1 emits a light beam FS1 through a first mirror M1. This mirror is such as the one which was described above with reference to FIGS. 3 and 4. The emission zone z1 of this light beam through the mirror is therefore non-reflective, or weakly reflective.

A second mirror M2, intended to orient the beam, reflects it toward a third mirror M3 which allows the beam to be focused toward the zone Z1 to be processed on the target C1.

A pointing adjustment source E1 emits a light beam FE1 which illuminates the target C1 in an illumination zone Z2. This zone Z2 has an area much greater than that of the zone Z1, and encloses it.

At least a part of the light of the beam FE1 is reflected by the target toward the mirror M3, which reflects it toward the mirror M2. This light is then reflected by the mirror M1, then by a mirror M4 toward a camera CA.

As explained above, however, the zone z1 of the mirror M1 through which the beam FS1 has been emitted is not very reflective. The camera CA therefore receives an image of the target in which the blind zone ZA appears less luminous or of a different color than the rest of the image of the target. The image obtained by the camera thus makes it possible to localize the blind zone ZA.

As regards the control of the pointing of the processing laser beam FS2, the system comprises a central control circuit CC for controlling pre-pointing of the entire pointing system in FIG. 5, so that the beams FS2 and FE1 are substantially directed toward the target C1 to be processed.

This pre-pointing is carried out on the basis of data provided by an IR imaging system which covers a field of from 1 to 3 degrees at a precision of the order of 500 μradians with a standard deviation at 3σ.

The pointing system of FIG. 5 is then put into operation. The illumination source emits the beam FE1, which is reflected by the target C1. As mentioned above, the photographic device receives the image of the target.

This image is transmitted to a processing circuit CT which identifies the size of the blind zone ZA and its position on the target.

If the size of the blind zone is greater than (or optionally equal to) the size of the target, the processing circuit carries out an angular displacement of the mirror M2, thereby angularly displacing the beam FS2 by a value such that the blind zone ZA is offset in the photographic device by a distance at least equal to the diameter of the blind zone.

The image obtained by the photographic device is transmitted to the processing circuit CT, which measures the distance between the center of the blind zone and a selected zone of the target C1 to be processed.

Via the link ct1, the processing circuit CT then controls the orientation of the mirror M2 in order to adjust the direction of the beam FS2 as a function of the result of the measurement which has just been carried out. Via the link ct2, it may also control the mirror M3 in order to adjust the focusing.

The photographic device may use a camera working in the 1.5 μm spectral range, operating at a rate of 1 kHz with a shutter system synchronized with the return of a short pulse (˜0.5 μs) generated by an illumination laser that provides an image by day and by night with a resolution on the target of from 0.15 to 0.3 m, with a sampling rate adapted to the passband required in order to correct the fluctuations of the atmospheric channel located between the emission optics and the target.

In the system of FIG. 5, the wavelengths emitted by the sources S1 and E1 advantageously have different values. In particular, the wavelength emitted by the source E1 is not contained in the wavelength range of the source S1. The invention then provides a spectral filter F1 which allows the wavelength (or wavelength range) emitted by the source E1 to be transmitted toward the camera. This reduces the risks that wavelengths of the beam FS2, which have been reflected by the target, will be returned, in order to avoid degrading the image acquired by the camera.

For example, the emission wavelength of the source E1 may be 1.5 micrometer, and the source S1 may emit at around 1.08 micrometer.

1. A system for pointing a laser beam, comprising:
at least one processing laser source for emitting a processing laser beam toward a target, said processing beam being transmitted through a non-reflective zone of a first mirror, said mirror allowing return to an imaging system receiving an illumination beam reflected by the target, said low reflection coefficient zone of the first mirror inducing a shadow zone toward the imaging system;
a second mirror receiving said processing beam and intended to orient it and reflect it toward the target;
an illumination source for illuminating said target with the aid of the illumination beam;
a first control circuit for controlling the orientation of said pointing system toward the target; and
a second control circuit for angularly displacing the processing beam by a determined angle, measuring the distance separating the position of a zone of the target from the position of the spot of the processing beam on the basis of an image obtained by the imaging system, then displacing the illumination beam in the opposite sense by an angle corresponding to said measured distance, the angular displacement of the processing beam having an amplitude such that the measurement of the position of the target is not perturbed by the shadow zone.

2. The system as claimed in claim 1, wherein said angle by which the processing beam is angularly displaced corresponds in the imaging system to the diameter of said shadow zone.

3. The system as claimed in claim 2, further comprising a third mirror intended to reflect the light received from the second mirror toward said target, or conversely to reflect the light received from the target toward the second mirror, this third mirror making it possible to adjust the focusing of the beam received from the second mirror.

4. The system as claimed in claim 3, further comprising a fourth mirror receiving the light received from the first mirror and reflecting it toward the imaging system.

5. The system as claimed in claim 1, wherein said processing beam has a first wavelength or wavelength range and said illumination beam has a second wavelength or wavelength range, different to the first wavelength or wavelength range, the system furthermore comprising a spectral filter, located between the first mirror and the imaging system, for transmitting only the second wavelength or wavelength range to the imaging system.

6. The system as claimed in claim 1, wherein the processing laser source comprises an emitting optical fiber or an assembly of a plurality of emitting optical fibers, one end of which lies flush with said reflective face, the surface of said end constituting said zone which reflects little or not at all, the reflective face and the surface of said end lying in the same plane and being inclined with respect to the axis of the emitting optical fiber or the assembly of emitting optical fibers.

7. The system as claimed in claim 1, wherein said first mirror comprises a face coated with a volume diffraction grating which comprises a hole in said zone for said processing beam to pass through, the diffraction efficiency of which is determined in order to deflect the quasi-monochromatic radiation of the illumination laser reflected by the target.
